(19) United States
(12) Patent Application Publication
(10) Pub. No.: US 2012/0006021 A1
(43) Pub. Date: Jan. 12, 2012

(54) HEAT EXCHANGER AND METHOD FOR PRODUCTION THEREOF

(76) Inventors: Christian Bausch, Bubesheim (DE); Jurgen Berger, Gerstetten (DE); Jens Grieser, Sohnstertten (DE)

(21) Appl. No.: 12/998,632

(22) PCT Filed: Nov. 16, 2009
(86) PCT No.: PCT/EP2009/008133

§ 371 Date: Jul. 29, 2011

(30) Foreign Application Priority Data
Nov. 19, 2008 (DE) 10 2008 058 210.7

(51) Int. Cl. F01K 23/10; B23P 15/26

(52) U.S. Cl. 60/618; 29/890.034

(57) ABSTRACT

The invention concerns a heat exchanger for transmitting heat from a heating medium, in particular from the exhaust gas stream of an internal combustion engine, to a working fluid, which evaporates in the heat exchanger, comprising an alternating stacking order made of guiding layers for the heating medium and guiding layers for the working fluid; wherein the heating medium and the working fluid are injected in the cross counterflow; whereas each guiding layer for the working fluid comprises a channel plate, which has at least one meandering passage opening, whereas cover plates are arranged on both sides of the channel plate, which cover plates seal laterally the passage opening by forming a working fluid channel, except for an inlet and an outlet, wherein the channel plate is materially connected to the cover plates; and whereas the working fluid channel includes a first section, outgoing from the inlet, with a first free cross-section and a second section emerging in the outlet, with a second free cross-section, which is larger than the first free cross-section.

The invention concerns heat exchangers, in particular for using the waste heat of an internal combustion engine by the evaporation of a working fluid for operating a steam engine, as well as a method of manufacturing for such a heat exchanger.

Waste heat recovery systems use the waste heat of an internal combustion engine for evaporating a working fluid, which is expanded in an expander by releasing mechanical power. Subsequently to the expander, the evaporation phase of the working fluid is condensed and conveyed to the heat exchanger again. The exhaust gas stream or the coolant stream are possible heat sources of an internal combustion engine for heating up the vaporiser. Additional heat sources are provided by the exhaust gas recirculation and charge air cooling of vehicle motors as well as the intercooling in case of multistage supercharging. Alternately or additionally, a separate burner unit can be provided.

Waste heat recovery systems may advantageously improve the overall efficiency of a drive unit with at least partial usage of the waste heat of an internal combustion engine. Despite this advantage, the components of the steam engine increase the total weight of the vehicle and moreover require additional construction space. Heat exchangers as a component of a waste heat recovery system should therefore be efficient, compact and adaptable to the respective application.

Heat exchangers with a heating register including a tube bundle are well-known. In a first embodiment the heat carrier medium flows around the outer walls of the tube bundle. In a further embodiment, hydraulically separated flow channel systems are provided for the working fluid as well as for the heat carrier medium. See for instance document GB 1084292 A. This publication discloses a plate heat exchanger, which is composed of an alternating stacking order of two types of plate. A first type of plate conveys the heat carrier medium, the second type of plate the working fluid to be evaporated. The flow channels in both types of plate are arranged as one-sided open channels, which are each covered by the closed side of the neighbouring plate. The shortcoming of such an arrangement is that the patterning of the various plate involves high production costs. This is particularly true for the production of a channel system with multiple branches in a plate so as to convey the corresponding medium with maximum turbulence. Moreover, the pattern of flow channels used for the working fluid to be evaporated must be adapted to the sizing of the waste heat recovery system and to the thermal power input available to the respective application. This requires most of the time an individual pattern adaptation, which in turn is costly. Besides, the high forces resulting from the steam pressure should be absorbed for the disclosed plate heat exchangers due to the elongation of the side surfaces. To cope with these high mechanical loads, the vaporisers have to be large-sized and heavy. Moreover, flat pipe vaporisers with serpentine structure are well-known. See for instance document DE 102 60 107 A1.

Besides, document DE 199 48 222 A1 discloses a heat exchanger in the form of a stack of plates, for which the flow channels for guiding the heat carrier medium and those for receiving the working fluid are designed with different cross-sections. To do so, the working fluid channels have advantageously small cross-sections to counteract the steam film forming on the walls of the working fluid channels, which unwantedly reduces the heat transfer into the liquid phase (Leidenforst phenomenon). It is suggested to that end to lay flat each of the two plates with channels arranged in a herringbone pattern. Cross channel patterns designed for the plates bearing against one another are used for the flow channels intended for guiding the heat carrier medium, so as to obtain the largest free cross-section as possible. For the narrow working fluid channels, a parallel arrangement of interlocking patterns for reducing the volume on the vaporiser side is preferred. The shortcoming is the resulting expensive construction. To do so, spacers are particularly necessary for the parallel arrangement of the channels. Moreover, scalability and individual cross-section adaptation as well as desired channel broadening for absorbing the evaporation phase are only possible to an insufficient extent.

The object of the invention is then to provide a heat exchanger, in particular for using the waste heat of an internal combustion engine, which permits an efficient heat transfer from a heating medium to a working fluid to be evaporated in the heat exchanger. To do so, the heat exchanger should have a compact design and additionally present a high stability to vibrations and shocks occurring typically in vehicle applications. Moreover, the vaporiser should be characterised by a small size and by an improved scalability. The scalability should promote the yield in heating medium and working fluid as well as the volume stream in the evaporation phase of the working fluid. A simple adaptability of the vaporiser to a determined type of vehicle as well as to different pressure requirements is desirable. Moreover, the working fluid should, when operating the heat exchanger, enter said exchanger in liquid form and exit therefrom in overheated vapor phase. Consequently, even working media with a corrosive effect with operating pressures of 60-100 bars and beyond that can be conveyed reliably in the heat exchanger.

The object of the invention is satisfied by the characteristics of the independent claim. Advantageous embodiments are divulged in the sub-claims.

The heat exchanger according to the invention includes two different function layers, which form an alternating stacking order. We mean here on the one hand guiding layers for the heating medium and on the other hand guiding layers for the working fluid. Each guiding layer for the working fluid comprises a patterned channel plate containing meandering passage openings. By passage openings are meant openings through the channel plate, reaching through the whole thickness dimension of the channel plate from the upper side to the lower side. Such passage openings can be obtained in the sheet metals used preferably for providing the channel plate with a thickness of preferably 0.2-2 mm, most preferably 0.3-1.5 mm, by means of a punching process or another appropriate patterning process, for instance by means of a laser cutting or etching process. A milling method or the application of extruded components can also be envisioned.

For obtaining a working fluid channel, each channel plate on the upper side and the lower side is provided with a cover plate which are materially connected to the channel plate when mounted. In this context, a solder connection, for example a Ni solder or a Cu solder is used in particular for producing the material bond. The cover plates are patterned in such a way that each working fluid channel is provided with an inlet and an outlet. Consequently, all the working fluid channels may present hydraulically connected inlets and outlets.

The patterning of the channel plate in conjunction with the cover plates generates a flat working fluid channel, which conveys the working fluid first of all entering in liquid condition with respect to the moving direction of the heating medium in cross counterflow. The result of this meandering is moreover a sufficient length of the working fluid channel for the evaporation and the post-overheating. According to the invention, the openings in the channel plate enable to adjust the free cross-section of the working fluid channel, by adapting the width of the channel plate perpendicular to the flow direction of the working fluid.

To do so, the working fluid channel includes a first section, outgoing from the inlet, with a first free cross-section as well as, subsequently in the flow direction, a second section with a second free cross-section, wherein the second free cross-section is selected to be larger than the first free cross-section. This configuration enables to widen the cross-section in the region of working fluid channel wherein the working fluid changes phase. Consequently, starting from a target pressure for the working fluid, the flow-through velocity of the working fluid channel can be adapted in the first section and in the second section of the working fluid channel, so that the second section, which conveys the evaporated working fluid, can be used efficiently for post-heating the evaporation phase.

It is hence preferable to use the widened cross-section when passing from the first section to the second section of the working fluid channel so as to modify the pressure substantially by leaps and bounds so that the working fluid is almost completely evaporated in this junction and no other additional precautionary measures need be taken in the heat exchanger for diverting a non-evaporated portion of condensate of the working fluid.

The invention is described below using exemplary embodiments in connection with figure illustrations, wherein the following details are shown:

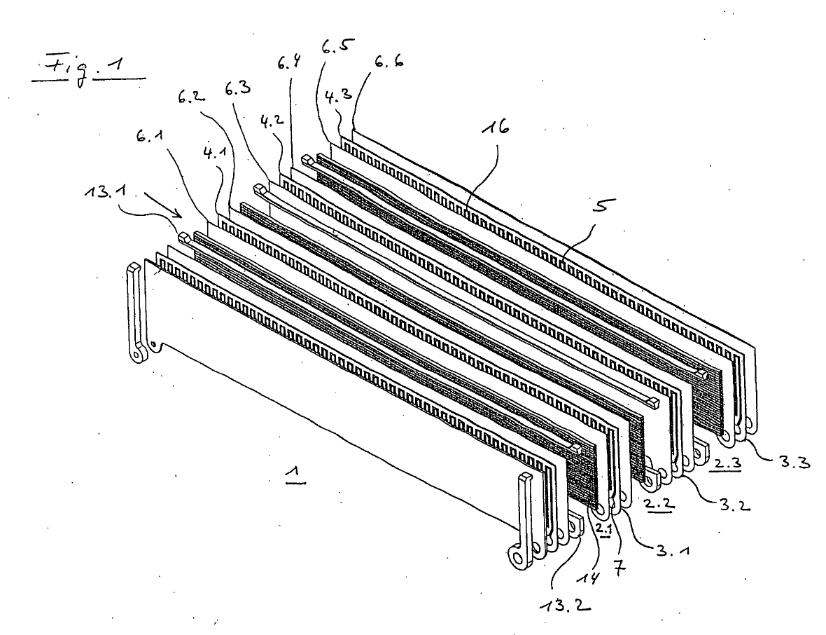

FIG. 1 shows a partial view of the stacking order of a heat exchanger according to the invention in exploded view.

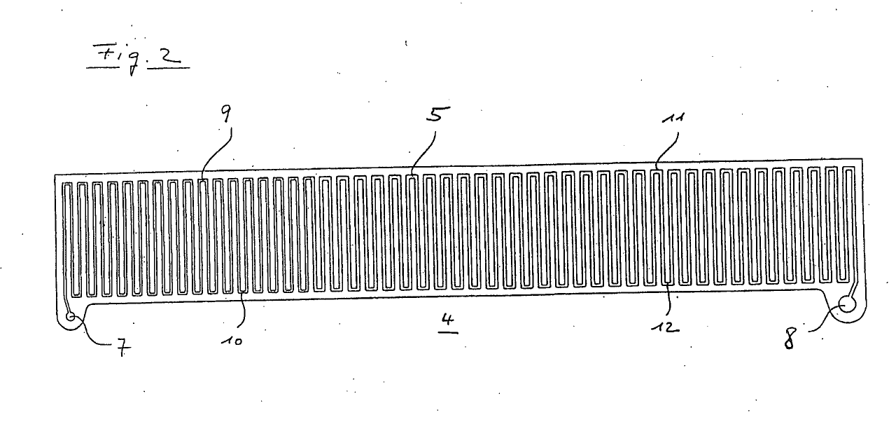

FIG. 2 shows an top view on a channel plate with a meandering passage opening.

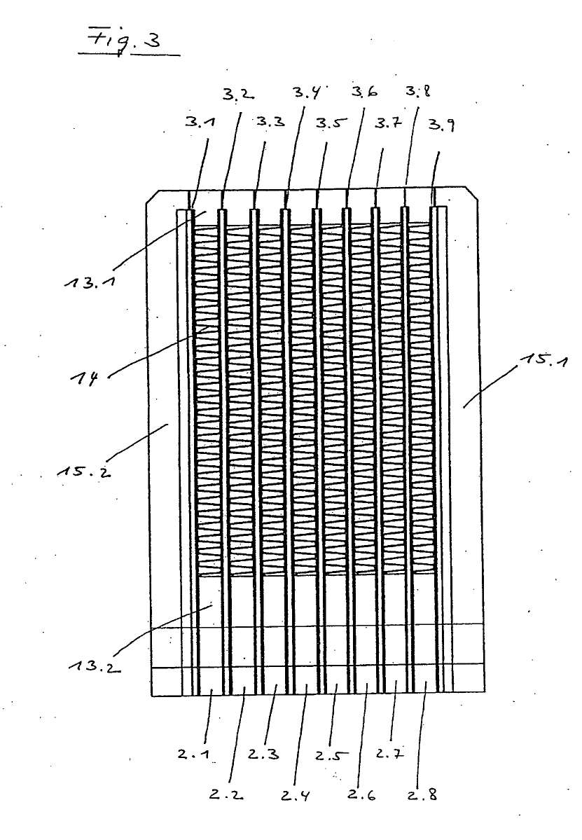

FIG. 3 shows a top view on the front of a heat exchanger according to the invention.

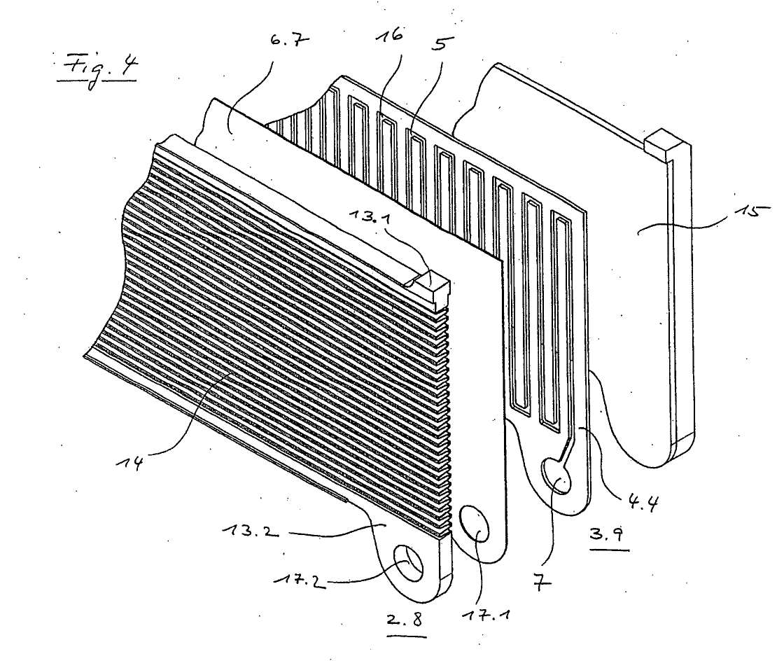

FIG. 4 shows the lateral termination of the stacking order of a heat exchanger according to the invention in exploded view.

FIG. 1 shows a partial view of the stacking order 1 of a heat exchanger according to the invention, comprising an alternating stacking order made of guiding layers for the heating medium 2.1, 2.2, 2.3 and guiding layers for the working fluid 3.1, 3.2, 3.3. The continuation of the stacking order 1 with additional guiding layers will not be illustrated in details.

Each of the guiding layers for the working fluid (3.1, 3.2, 3.3) is composed of individual superficially contacting components. Consequently, a channel plate 4.1, 4.2, 4.3 is systematically arranged centrally in each guiding layer for the working fluid 3.1, 3.2, 3.3. Such a channel plate 4 is depicted on FIG. 2 as a separate side view.

The channel plate 4 comprises a passage opening 5, which extends through its whole thickness dimension and which starts from an inlet 7 and emerges in an outlet 8. To do so, the width of the passage opening 5 is modified between the inlet 7 and the outlet 8. First of all, a first section 9 with a first free cross-section 10 comes after the inlet 7, whereas said first section turns into a second section 11 with a second free cross-section 12 further along. Consequently, the second free cross-section 12 is widened with respect to the first free cross-section 10.

If a pair of laterally terminating cover plates 6.1-6.6 is allocated to the channel plate 4, there is a working fluid channel 14 with two different sections, which differentiate by their cross-section. The widening of the cross-section creates an increased volume of absorption for the vapor phase in the precise region of the working fluid channel 14, wherein the working fluid is evaporated, so that the flow velocity does not increases unwantedly after completion of the phase change and an efficient post-overheating of the vapor phase can be triggered in the second section 11. Besides, the widened cross-section enables better localisation of the place of the change in phase in the working fluid channel 16.

Preferably, the channel plates 4.1, 4.2 and 4.3 as well as the respective associated cover plates 6.1-6.6 consist of a thin-walled sheeting material wherein the thickness of the metal plate is selected preferably in the region between 0.2 and 2 mm and most preferably in the interval between 0.3 and 1.5 mm. The preferred material is either stainless steel or an aluminium alloy. To do so, the meandering passage openings 5 can be arranged in the respective channel plates 4.1, 4.2, 4.3 by means of an appropriate patterning process. To do so, a punching process or a patterning by means of an etching process or a milling method can be used. Moreover, laser can come advantageously into play for patterning.

The channel plates 4.1, 4.2, 4.3 illustrated on FIG. 1 and the respective corresponding cover plates 6.1, 6.2, 6.3, 6.4, 6.5, 6.6 are materially connected preferably in operation-ready condition. This enables to provide an advantageous embodiment also for the additional components of the stacking order 1, used for obtaining the guiding layers for the heating medium 2.1, 2.2, 2.3. The material bond can for instance be performed by a hard solder connection by means of a Ni solder or of a Cu solder. A welded connection can be envisioned alternately.

To do so, the material connection is favoured by the large-area construction of the channel plate 4, so that sufficiently large abutment regions are present on the rim of the respective channel plate 4 and in the region of the intermediate webs between the various meandering branches of the passage opening 5, which are first of all brought in abutment against the respective laterally adjoining cover plates 6.1-6.6 and then a material bond is formed by applying a pressure and by means of a thermal treatment. In a preferred method of manufacturing, all the components of the guiding layers for the heating medium 2.1, 2.2, 2.3 as well as of the guiding layers for the working fluid 3.1, 3.2, 3.3 are accommodated in the stacking order 1 and centred in a further step. The stacking order 1 is then secured in the stacking direction by applying force. A preferred thermal treatment at temperatures in the region between 1000 and 1250° C. then creates the desired material bond of the components of the stacking order 1 of the heat exchanger.

The guiding layers for the heating medium 2.1, 2.2, 2.3 are generated by the creation of an intermediate space with respect to the neighbouring guiding layers for the working fluid 3.1, 3.2, 3.3. The stacking order 1 contains for that purpose spacers 13.1, 13.2 which are designed in such a way that the inlets 7 of all channel plates 4.1, 4.2, 4.3 are connected to each other hydraulically. The same goes for the outlets 8 of the channel plates 4.1, 4.2, 4.3. Besides, the spacers secure 13.1, 13.2 the fluid-tight termination of the respective guiding layers for the working fluid 3.1, 3.2, 3.3 perpendicular to the through-flow direction.

Moreover, a flow baffle plate 14 is preferably provided for each guiding layer for the heating medium 2.1, 2.2, 2.3, whereas said baffle plate is an undulated structure in the simplest case which forms flow channels in longitudinal direction, that is to say in the flow-through direction for the heating medium. The flow baffle plates 14 enable to improve the heat transfer to the adjoining cover plates 6.1-6.6. Moreover, the flow baffle plates 14 can be fitted with an additional functional coating, which for instance provides corrosion protection or presents a catalytic effect.

FIG. 3 shows a top view on the front of a heat exchanger according to the invention, through which the heating medium enters or exits. The alternating stacking order made of the guiding layers for the heating medium 2.1, 2.2, 2.3, . . . , 2.8 and of the guiding layers for the working fluid 3.1, 3.2, 3.3, . . . , 3.9 is in turn clearly visible. Additionally, the rim plates 15.1 and 15.2 are represented which form the side walls of the heat exchanger. In a preferred embodiment, said walls are provided with a thermal insulation.

The lateral termination of the stacking order 1 can be seen further in the enlarged exploded view illustrated on FIG. 4. There is shown the channel plate 4.4 adjoining the rim plate 15 with the passage opening 5 arranged therein. Said plate is loaded with a working fluid in liquid phase via the inlet 7, before evaporation upstream in the working fluid channel 16. The second lateral surface of the channel plate 4.4 is sealed by the cover plate 6.7 in operating condition. To do so, the cover plate 6.7 presents a passage opening 17.1, aligned with the inlet 7 in the channel plate 4.4. A matching passage opening 17.2 is arranged in the spacer 13.2. This forms together with the spacer 13.1 and the flow baffle plate 14 the immediately adjoining guiding layer for the heating medium 2.4.

The examples of embodiment of the invention described above concern the application of flat components in the stacking order 1. Advantageous embodiments can however be envisioned for which the guiding layers for the heating medium and the guiding layer for the working fluid are bent by design. Cylindrical components are advantageously provided, which coaxially arranged enclose a tubular building component of a vehicle drive. This can be a particle filter of a diesel engine which serves at the same time as an energy storage device since a large quantity of heat is released in case of thermal filter cleaning from built up soot particles. It may also be envisioned to use the heat exchanger for cooling a vehicle component, such as the catalyser unit of an Otto engine. The guiding layers for the heating medium can be dispensed with for both application cases, when a direct thermal contact is formed between the respective vehicle component and the adjoining guiding layer for the working fluid. Cylindrical stacking orders are not represented in detail on the figures.

Further embodiments of the invention can be contemplated. This enables consequently to improve the through-mixing of the heating medium in the guiding layer for the heating medium and of the working fluid in the guiding layer for the working fluid thanks to elements intended for generating whirls. For that purpose, the surface roughness of the side surfaces of the fluid-carrying channels can be raised. Moreover, embodiments not illustrated in more detail with corrugated side surface contours for the passage opening 5 in the channel plates 4.1-4.4 are advantageous for improved through-mixing.

### LIST OF REFERENCE NUMERALS

1 Stacking order
2.1, 2.2, 2.3,
2.4, . . . , 2.8 Guiding layers for the heating medium
3.1, 3.2, 3.3,
3.4, . . . , 3.9 Guiding layer for the working fluid
4.1, 4.2, 4.3,
4.4 Channel plate
5 Passage opening
6.1, 6.2, 6.3,
6.4, . . . , 6.7 Cover plate
7 Inlet
8 Outlet
9 First section
10 First free cross-section
I1 Second section
12 Second free cross-section
13.1, 13.2 Spacer
14 Flow baffle plate
15, 15.1,
15.2 Rim plate
16 Working fluid channel
17.1, 17.2 Passage opening

1-14. (canceled)

15. A waste heat recovery system, including:
an internal combustion engine, with an exhaust gas or coolant stream generating waste heat as a heating medium and with a heat exchanger for transmitting heat from the heating medium to a working fluid, which is evaporated by means of the waste heat, wherein the evaporated working fluid is expanded in an expander by releasing mechanical power and then condensed;
characterised in that:
the heat exchanger comprises:
an alternating stacking order made of guiding layers for the heating medium and guiding layers for the working fluid; in which the heating medium and the working fluid are guided in the cross counterflow;
each guiding layer for the working fluid comprises a channel plate, which has at least one meandering passage opening, whereas cover plates are arranged on both sides of the channel plate, which cover plates seal laterally the passage opening by forming a working fluid channel, except for an inlet and an outlet, and whereas
the channel plate is materially connected to the cover plates; and whereas
the working fluid channel includes a first section, outgoing from the inlet, with a first free cross-section and a second section emerging in the outlet, with a second free cross-section, which is larger than the first free cross-section.

16. The waste heat recovery system according to claim 15, characterised in that the heat exchanger is designed exclusively for guiding the working fluid and the heating medium.

17. The waste heat recovery system according to claim 15, characterised in that at least one guiding layer for the heating medium comprises spacers, for spacing adjoining cover plates apart from one another.

18. The waste heat recovery system according to claim 16, characterised in that at least one guiding layer for the heating medium comprises spacers, for spacing adjoining cover plates apart from one another.

19. The waste heat recovery system according to claim 17, characterised in that the spacers are designed as flow baffle plates.

20. The waste heat recovery system according to claim 18, characterised in that the spacers are designed as flow baffle plates.

21. The waste heat recovery system according to claim 15, characterised in that the guiding layers for the heating medium and the guiding layers for the working fluid are materially connected.

22. The waste heat recovery system according to claim 16, characterised in that the guiding layers for the heating medium and the guiding layers for the working fluid are materially connected.

23. The waste heat recovery system according to claim 17, characterised in that the guiding layers for the heating medium and the guiding layers for the working fluid are materially connected.

24. The waste heat recovery system according to claim 21, characterised in that a soldering process, preferably by means of a Ni solder or a Cu solder, or a welding process is used to obtain a material connection.

25. The waste heat recovery system according to claim 21, characterised in that a soldering process by means of a Ni solder is used to obtain a material connection.

26. The waste heat recovery system according to claim 15, characterised in that the channel plate and/or the cover plates of the guiding layer for the working fluid consist of a metal plate of stainless steel or an aluminium alloy.

27. The waste heat recovery system according to claim 26, characterised in that the metal plate has a thickness of 0.2-2 mm, preferably of 0.3-1.5 mm.

28. The waste heat recovery system according to claim 15, characterised in that the guiding layers for the working fluid are designed as flat layers or coaxial cylindrical layers.

29. The waste heat recovery system according to claim 15, characterised in that the guiding layers for the heating medium comprise elements for generating whirls.

30. The waste heat recovery system according to claim 15, characterised in that the guiding layers for the heating medium are provided with an anticorrosive and/or catalytically active coating.

31. A method of manufacture of a heat exchanger of a waste heat recovery system according to claim 15, characterised in that in a first manufacturing step the components for obtaining the guiding layers for the heating medium and the guiding layers for the working fluid are stacked and centred and in a subsequent manufacturing step the elements are materially bonded by applying force in the stacking direction.

32. The method of claim 31, characterised in that the components of the heat exchanger are heated for obtaining the material bond.

33. The method of claim 31, characterised in that the meandering passage opening in the channel plate is obtained by a punching or milling method or an etch or laser patterning.

34. The method of claim 32, characterised in that the meandering passage opening in the channel plate is obtained by a punching or milling method or an etch or laser patterning.
